(19) United States
(12) Patent Application Publication
(10) Pub. No.: US 2006/0118232 A1
(43) Pub. Date: Jun. 8, 2006

(54) Process of fabricating a laminated hollow composite cylinder with an arranged ply angle

(76) Inventors: Geng-Wen Chang, Taipei City (TW); Mau-Yi Huang, Banciao City (TW); Chin-Lung Lin, Taoyuan City (TW); Chih-Chin Lu, Jhonghe City (TW)

Correspondence Address: RABIN & BERDO, P.C., Suite 500, 1101 14 Street, N.W., Washington, DC, 20005, US

(21) Appl. No.: 11/002,152

(22) Filed: Dec. 3, 2004

(51) Int. Cl. B29C 47/00

(52) U.S. Cl. 156/245

(57) ABSTRACT

A manufacture method of a laminated hollow composite cylinder with an arranged ply angle is disclosed. The fiber in the hollow composite cylinder can be arranged in an angle Φ between 30° and 60° according the applications. Prepregs were cut into fan-shaped pieces and laminated in a metal mold to form an annular lamina assembly. The metal mold comprises a concave female mold and a convex male mold that both have a tapered angle complying with the ply angle Φ. Hot press molding with pressure over 140.6 kg/cm² was then used for solidifying the lamina assembly to produce the composite hollow cylinders with the ply angle Φ. The laminated hollow composite cylinder can achieve excellent thermal and mechanical properties to meet design requirements.

### BACKGROUND OF THE INVENTION

1. Field of Invention

The present invention relates to a process of manufacturing a laminated hollow composite cylinder with an arranged ply angle.

2. Related Art

Phenolic resin composite materials are conventionally known for its thermal insulating and flame retardant characteristics, and are conventionally used in aerospace and defense industries, such as fireproof materials in commercial aircrafts, thermal insulator in missiles and rocket launching systems, heat shields of metallic structures in human or unmanned space vehicles, etc.

Carbon fiber fabrics and phenolic resin are usually combined to form a composite material that has advantageous mechanical and thermal properties, the carbon fiber fabrics being able to resist to temperatures above 2000° C. within a short duration and offer superior mechanical strength. This type of composite materials thus has become the principal thermal insulator in aerospace and defense technologies. Industrialized countries thus have put major investments in the development of this material with respect to every aspect including the raw material, the manufacture process, or the assembly of component parts.

U.S. Pat. No. 6,013,361 disclosed an autoclave process for manufacturing a carbon fabric reinforced phenolic resin composite which has porosity of at least 4% by volume. Network pores of the composite material allow volatile gas escape. When the composite material is heated, the volatile formed by decomposition of phenolic resin in the composite material at high temperature is released via the network pores, so that the composite material can sustain a sufficient strength under high temperature. This type of composite material can be used in fireproof structures of Space Shuttles.

In the reference of Recent Advances in Composites Materials (ASME MD-Vol 56, 1995) disclosed by Daewoo Heavy Industries, Ltd, the ablative heat shield of a rocket launching system applies a composite thermal insulating structure, composed of a sandwich structure design, which is surface coated with a 15 mm-thick parallel laminated carbon fiber fabric reinforced phenolic resin composite by autoclave process.

In addition to the influence of the raw material and the manufacture process on characteristics of the carbon fiber fabric reinforced phenolic resin composite, the external heat source and the orientation of fiber are also factors which determine the thermal insulating characteristics of the composite. One research indicates that the 3.7 m diameter solid rocket booster (SRB) of Space Shuttle uses an ablative throat insert made of carbon fiber fabric reinforced phenolic resin composite material, which the optimal angles between the plies and the flame surface in SRB nozzles has been proven to be between 30 degrees and 60 degrees, depending upon the location, contour and heating conditions at various sections of the nozzle.

NASA PD-ED-1218 discloses a rocket nozzle in which an ablative part with ply angle of 45 degree is manufactured by using a tape wrapper to attach 45 degree bias-cut tapes over a mandrel and curing with a hydroclave.

The above references related to composite ablative part with designed ply angle have the following common demands:

1. An autoclave process should be used to cure the ablative part. This process requires a sophisticated vacuum package sequence, a well suitable designed curing cycle and an expensive autoclave equipment. Moreover, the autoclave can only provide a pressure not more than 35.1 kg/cm2 (500 psi). For achieving the required process pressure that is up to 1000 psi or higher, a more expensive hydroclave equipment is needed.

2. To obtain the desired ply angle, it is necessary to use bias-cut prepreg tapes and a tape wrapper, which are also expensive.

In this invention, a manufacture method of hollow composite cylinders with an arranged ply angle is disclosed. The plies in the hollow composite cylinders were arranged in ply angle Φ with respect to flow direction. Carbon fabric reinforced phenolic prepregs were cut into fan-shaped pieces and laminated in a mold including a concave female mold and a convex male mold both have a tapered angle Φ by which the ply angle Φ of the laminated hollow composite cylinder is formed. Hot press molding with pressure over 140.6 kg/cm2 is then used for solidifying the lamina assembly to get the composite hollow cylinder with arranged ply angle Φ.

### SUMMARY OF THE INVENTION

It is therefore an object of the invention to provide a process of manufacturing a laminated hollow composite cylinder with an arranged ply angle, satisfying requirements of high temperature resistant, thermal insulation and strength requirement, without using such expensive equipment as tape wrapper and autoclave/hydroclave.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus are not limited, and wherein:

FIG. 1 schematically shows the ply angle (Φ) to heat flow of the laminated hollow composite cylinder according the invention;

FIG. 2A and FIG. 2B show the design of the fan-shaped slice according to the invention;

FIG. 3 shows the metal mold for manufacturing the laminated hollow composite cylinder with an arranged ply angle according the invention;

FIG. 4 schematically shows a first annular layer of the fan-shaped slices to form the hollow lamina assembly according to the invention;

FIG. 5 is a section view of the accomplished hollow lamina assembly according to the invention;

FIG. 6 is a typical temperature-pressure curing curve of the laminated hollow composite cylinder according to one embodiment of the invention.

### DETAILED DESCRIPTION OF THE INVENTION

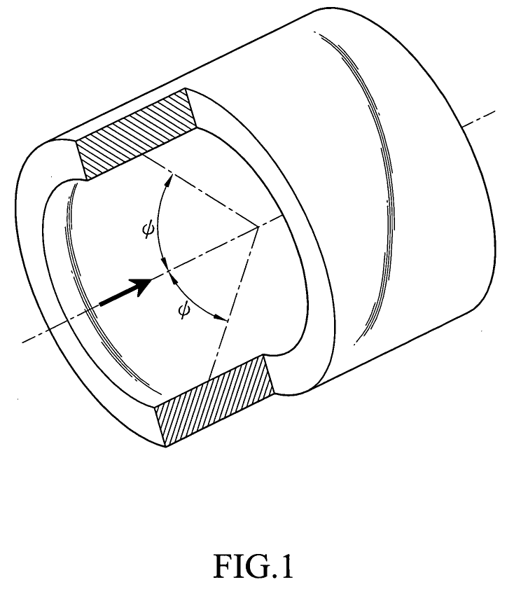

Laminated hollow composite cylinder according to the invention has fiber arranged at a ply angle with respect to heat source (such as flame or hot air) as shown in FIG. 1. Thereby, the thermal resistance can be enhanced.

The laminated hollow composite cylinder with arranged ply angle can be used as ablative liner of the rocket nozzle in missile system and rocket launching system to stand high intensity of heat in short duration. When the solid rocket missile propulsion is operating, its solid fuel burns to generate a great deal of heat that increases the temperature to 2000-3000° C. in a very short duration. Therefore, the ablative liner of the rocket nozzle must resist, in addition to high temperature, great thermal stress due the high temperature gradient.

For a conventional composite cylinder in which prepreg piles are co-axially rolled and cured on a cylinder mandrel (Φ=0), the heat flows through the piles from interior to exterior of the cylinder wall, which will deteriorate the heat resistance and flame resistance of the composite cylinder because of ply lifting.

The manufacture of the laminated hollow composite cylinder with arranged ply angle according to the invention includes cutting the prepregs into fan-shaped slices; laminate the slices on a tapered female mold to form a hollow cylinder assembly with a ply angle; and thermally molding the lamina assembly by hydraulic press.

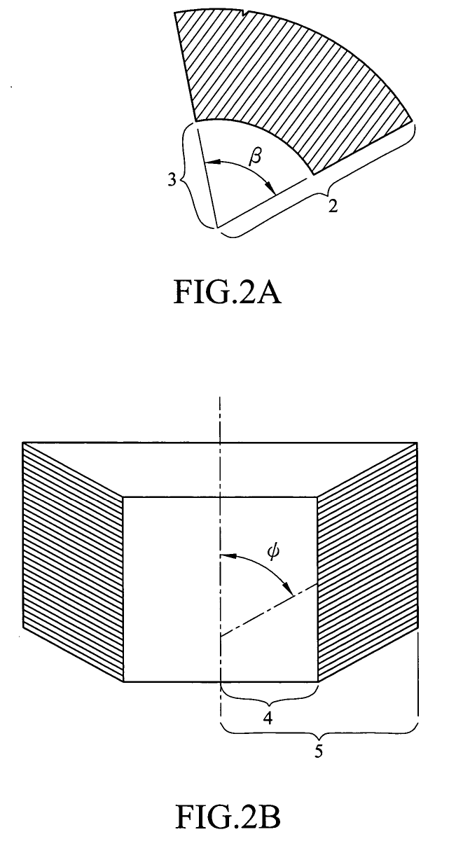

The prepregs of carbon fabric impregnated with phenolic resin, for example that are usually used to manufacture ablative part of rocket nozzle are cut through a punch machine into slices 1 as shown in FIG. 2 and FIG. 2B. The slices are of fan shape and have long diameter 2 (R1), short diameter 3 (R2). The composite cylinder has an inner diameter 4 (r2) and an outer diameter (r1). Those diameters are in the following relationships: R1=r1/sin Φ; R2=r2/sin Φ. The fan-shaped slices have an included angle β that depends on the size of the slices. The included angle β can be, for example, 45°, 60°, 75°, 90°, and 120°, etc.

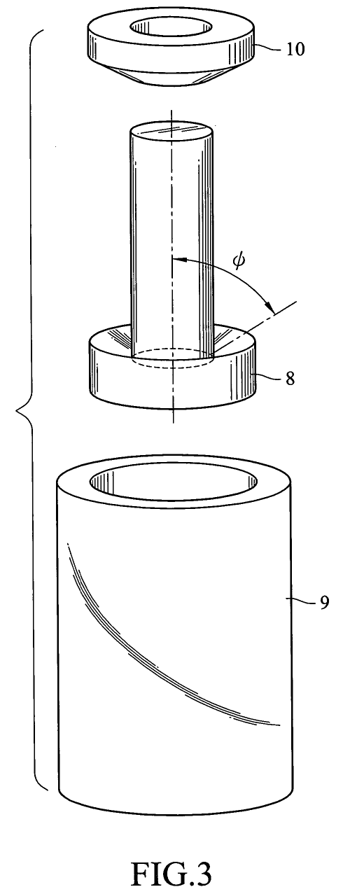

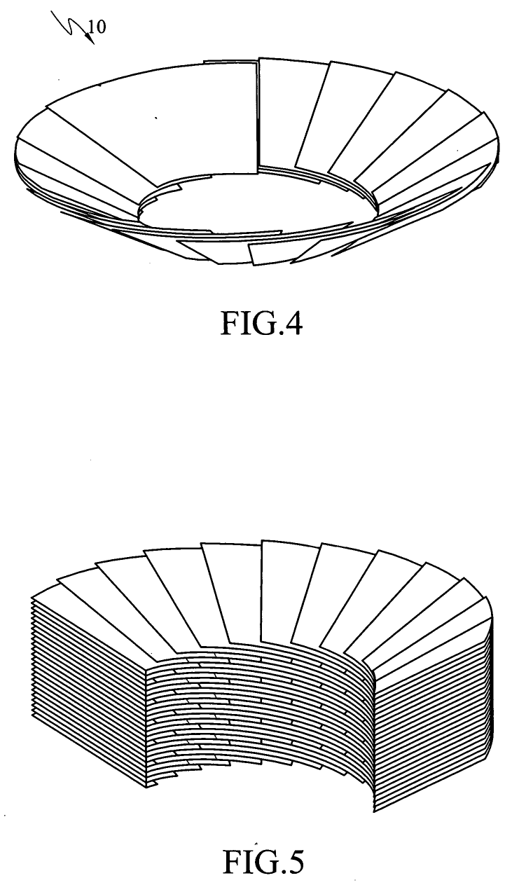

The fan-shaped slices are the laminate units. The amount of the laminate units determines the length of the cylinder. A predetermined amount or weight of slices is laminated over a female mold 8 as shown in FIG. 3. The female mold has a tapered bottom of angle Φ with respect to the axis of the female mold. The angle Φ, which is also the ply angle of the hollow composite cylinder, can preferably be 30°≦Φ≦60° according to the final applications of the composite cylinder. Each slice has a cut 7 at the long side for alignment. The slices are partially overlapped one another with the aids of the cut 7 to uniformly form a first annular layer 11 as shown in FIG. 4. Note that the last slice of the first annular layer is laminated above the first one. The procedure is repeated until all the pre-weighted slices have been laminated. Thereby, a lamina assembly of the hollow composite cylinder 13 is accomplished. FIG. 5 is a cross-sectional view of the hollow lamina assembly according to one embodiment of the invention.

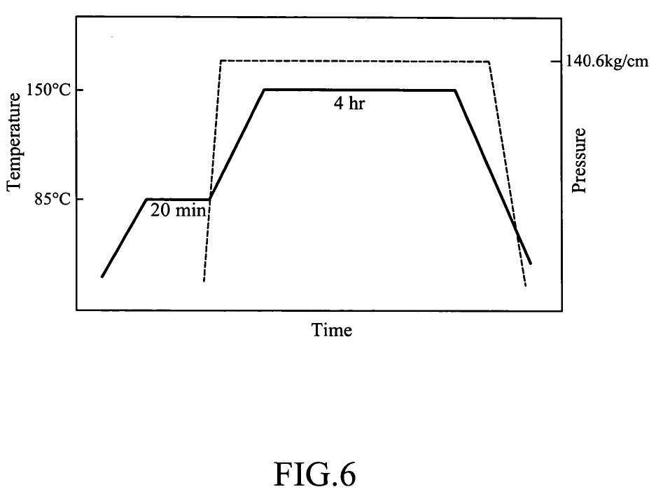

The lamina assembly including the slices is put together with the female mold 8 into an outer mold 9. A male mold 10 that has a protruding cone complying with the tapered cone of the female mold 8 is pressed onto the female mold 8. After hot press molding, a laminated composite hollow composite cylinder with arranged ply angle is obtained. A typical temperature-pressure curing curve of the laminated hollow composite cylinder is shown in FIG. 6

The obtained laminated hollow composite cylinder can be optionally machined to desired shape.

The laminated hollow composite cylinder with arranged ply angle has the following advantages:

1. The ply angle Φ can be designed according to the inner contour of the nozzle to enhance the thermal resistance and structural strength;

2. No particular tape wrapper is needed. Instead, the prepregs are cut into fan-shaped slices and laminated to form a lamina assembly with the facilitation of the cut for alignment to help uniform arrangement of the slices and thereby reducing thermal stress due to high temperature gradient;

3. The whole process is simple. A hot press is used with pressure over 140.6 Kg/cm2. Electrically or steam heating can be used.

4. No surface wrinkle, internal delamination that always happens in autoclave process.

The process according to the invention can provide a hollow composite cylinder of different thermal resistance, thermal insulation and strength as desired.

The typical laminated hollow composite cylinder with arranged ply angle made of carbon fiber reinforced phenolic resin prepreg has the following properties: density of 1.42-1.46 g/cm3, tensile strength of 5200-7000 kg/cm2, flexural strength of 3500-6000 kg/cm2, interlaminar shear strength of 175-270 kg/cm2, specific heat of 1.2-1.23 J/g ° C. and thermal diffusivity coefficient of 2.6-2.8×10⁻³ cm⁻³/sec.

### EXAMPLE 1

The production of laminated carbon reinforced phenolic resin hollow composite cylinder with 195 cm in height, 170 cm in outer diameter, 85 cm in inner diameter and ply angle 60°

Aerospace grade PAN-based carbon fiber fabrics (Hexcel 584) and an ammonia catalyst phenolic resin are used to obtain prepregs. Then, the prepregs are cut into fan-shaped slices with 196 cm (170/sin Φ) in long diameter and 99 cm (85/sin Φ) in short diameter, totally weight of 5400 g. At one-fourth location of the long side of each fan-shaped slice, there is a small cut for alignment.

A metallic mold with 340 cm in height, 85 cm in inner diameter and 170 cm in outer diameter is provided. The metallic mold has a female mold having a tapered cone bottom with an angle of 60°, and a male mold having a projecting cone corresponding to the tapered cone bottom of the female mold. The mold has been coated with chromium and polished, and a release wax (CIBA Crown Wax) has been applied over the mold already. The fan-shaped slices are uniformly laminated on the female mold to form a first annular layer with the aids the cuts for alignment. The procedure is repeated until the whole 5400 g slices are laminated to form a hollow cylinder lamina assembly.

The lamina assembly is placed together with the mold on the hot press. The hot press molding includes three stages. The first stage is conducted at molding pressure of 140.6 kg/cm2 and temperature of 85° C. for 20 minutes. At the second stage, the temperature is firstly increased to 150° C. at a rate of 1.3° C./min, then kept at 150° C. for 4 hours. The third stage is cooling. After the hot press molding, the hollow composite cylinder with 60-deg. ply angle is removed from the metallic mold and subjected to ASTM D2344 test. It is found that the interlaminar shear strength at room temperature is 175.5 kg/cm2 in average, and the average density is 1.45 g/cm2.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A process of fabricating a laminated hollow composite cylinder with an arranged ply angle, comprising the steps of:
cutting a plurality of prepregs into fan-shaped slices;
laminating the slices in a metal mold to form a lamina assembly; and
hot press molding the lamina assembly to obtain the hollow composite cylinder.

2. The process of claim 1, wherein the arranged ply angle is 30°≦Φ≦60°.

3. The process of claim 1, wherein each fan-shaped slice has a long diameter R1 and a short diameter R2, which are in the following relationships with outer diameter r1 and inner diameter r2 of the hollow composite cylinder: R1=r1/sin Φ; R2=r2/sin Φ.

4. The process of claim 1, wherein each fan-shaped slice has an included angle β that determines the size of the slices.

5. The process of claim 1, wherein each fan-shaped slice has a cut for alignment to facilitate uniformly laminating.

6. The process of claim 1, wherein the laminating process is conducted by partially overlap the slices one another to form a first annular lamina assembly, then the process is continued to form a hollow cylinder assembly.

7. The process of claim 6, wherein the last slice in the first annular lamina is laminated over the first slice.

8. The process of claim 1, wherein the metal mold comprises a concave female mold and a convex male mold that both have a tapered angle complying with the arranged ply angle Φ.

9. The process of claim 1, wherein the hot press molding process is conducted with a pressure of more than 140.6 Kg/cm2.
